(19) United States
(12) Patent Application Publication
(10) Pub. No.: US 2012/0176561 A1
(43) Pub. Date: Jul. 12, 2012

(54) Liquid crystal display

(76) Inventors: Gee-Bum Kim, Yongin-City (KR); Won-Sang Park, Yongin-city (KR); Jae-Hyun Kim, Yongin-city (KR); Jong-In Baek, Yongin-city (KR)

(21) Appl. No.: 13/137,810

(22) Filed: Sep. 14, 2011

(30) Foreign Application Priority Data
Jan. 10, 2011 (KR) 10-2011-0002344

(51) Int. Cl. G02F 1/1343; G02F 1/1368

(52) U.S. Cl. 349/46; 349/43

(57) ABSTRACT

A liquid crystal display includes a gate line and a data line on a substrate and intersecting each other, a pixel region defined by the gate line and the data line, a pixel electrode in the pixel region, a thin-film transistor (TFT) in the pixel region, and a common electrode over or under the pixel electrode. The TFT is configured to apply a voltage to the pixel electrode. The common electrode is configured to generate an electric field with the pixel electrode and is on a higher layer than the data line. The common electrode is excluded in a region of the higher layer that overlaps the data line.

### CROSS-REFERENCE TO RELATED APPLICATION

This application claims priority from Korean Patent Application No. 10-2011-0002344 filed on Jan. 10, 2011 in the Korean Intellectual Property Office, the disclosure of which is incorporated herein by reference in its entirety.

### BACKGROUND

Embodiments relate to display devices such as liquid crystal displays (LCD). Liquid crystal displays (LCDs) are one of the most widely used flat panel displays. An LCD may include a pair of substrates having electrodes and a liquid crystal layer interposed between the substrates. In an LCD, voltages may be applied to electrodes to rearrange liquid crystal molecules of a liquid crystal layer, thereby controlling the amount of light that passes through the liquid crystal layer.

### SUMMARY

Embodiments may be realized by providing an LCD including a gate line and a data line formed on a substrate and intersecting each other; a pixel region defined by the gate line and the data line; a pixel electrode formed in the pixel region; a thin-film transistor (TFT) formed in the pixel region and applying a voltage to the pixel electrode; and a common electrode formed over or under the pixel electrode and generating an electric field together with the pixel electrode, wherein the common electrode is formed on a higher layer than the data line and is not formed in a region of the higher layer which is over the data line.

Embodiments may also be realized by providing an LCD including a gate electrode formed on a substrate; a gate insulating film formed on the gate electrode; a semiconductor layer formed on the gate insulating film and overlapping the gate electrode; a data line formed on the gate insulating film; source and drain electrodes branching from the data line and formed on the semiconductor layer and the gate insulating film to be separated from each other by a predetermined gap; a first passivation layer formed on an entire surface of the substrate having the source and drain electrodes and the data line; a common electrode formed on the first passivation layer; a second passivation layer formed on the common electrode; and a pixel electrode formed on the second passivation layer, wherein the common electrode is not formed in a region of the first passivation layer which is over the data line.

Embodiments may also be realized by providing an LCD including a gate electrode formed on a substrate; a gate insulating film formed on the gate electrode; a semiconductor layer formed on the gate insulating film and overlapping the gate electrode; a data line formed on the gate insulating film; source and drain electrodes branching from the data line and formed on the semiconductor layer and the gate insulating film to be separated from each other with respect to the gate electrode; a pixel electrode formed on the gate insulating film and connected to the drain electrode; a passivation layer formed on an entire surface of the substrate having the source and drain electrodes, the pixel electrode, and the data line; and a common electrode formed on the passivation layer, wherein the common electrode is not formed in a region of the passivation layer which is over the data line.

### BRIEF DESCRIPTION OF THE DRAWINGS

Features will become apparent to those of ordinary skill in the art by describing in detail exemplary embodiments with reference to the attached drawings, in which:

FIG. 1 illustrates a plan view of a thin-film transistor (TFT) substrate included in a liquid crystal display (LCD) according to an exemplary embodiment;

FIG. 2 illustrates a cross-sectional view taken along the line I-I′ of FIG. 1;

FIG. 3 illustrates a schematic plan view of a common electrode included in the LCD according to the exemplary embodiment of FIG. 1;

FIG. 4 illustrates a schematic cross-sectional view of the LCD according to the exemplary embodiment of FIG. 1;

FIG. 5 illustrates a cross-sectional view of a TFT substrate included in an LCD according to an exemplary embodiment;

FIG. 6 illustrates a plan view of a TFT substrate included in an LCD according to an exemplary embodiment;

FIG. 7 illustrates a cross-sectional view taken along the II-II′ of FIG. 6;

FIG. 8 illustrates a plan view of a TFT substrate included in an LCD according to an exemplary embodiment;

FIG. 9 illustrates a cross-sectional view taken along the line of FIG. 8;

FIG. 10 illustrates a schematic plan view of a common electrode included in the LCD according to the exemplary embodiment of FIG. 8;

FIG. 11 illustrates a plan view of a TFT substrate included in an LCD according to an exemplary embodiment; and

FIG. 12 illustrates a cross-sectional view taken along the line IV-IV′ of FIG. 11.

### DETAILED DESCRIPTION

Korean Patent Application No. 10-2011-0002344, filed on Jan. 10, 2011, in the Korean Intellectual Property Office, and entitled “Liquid Crystal Display,” is incorporated by reference herein in its entirety.

Features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the scope of the invention to those skilled in the art, and the present invention will only be defined by the appended claims. In the drawings, sizes and relative sizes of layers and regions may be exaggerated for clarity.

It will be understood that when an element or layer is referred to as being “on” another element or layer, the element or layer can be directly on another element or layer or intervening elements or layers may also be present. In contrast, when an element is referred to as being “directly on” another element or layer, there are no intervening elements or layers present. As used herein, the term “and/or” includes any and all combinations of one or more of the associated listed items.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. Like reference numerals refer to like elements throughout the specification.

Exemplary embodiments are described herein with reference to plan and cross-section illustrations that are schematic illustrations of idealized embodiments. As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the invention.

Hereinafter, a liquid crystal display (LCD) will be described in further detail with reference to the accompanying drawings.

The LCD may have a thin-film transistor (TFT) substrate which includes a TFT in each pixel region defined by a gate line and a data line, an opposite substrate which is opposite the TFT substrate and includes color filters, and a liquid crystal layer which is interposed between the TFT substrate and the opposite substrate.

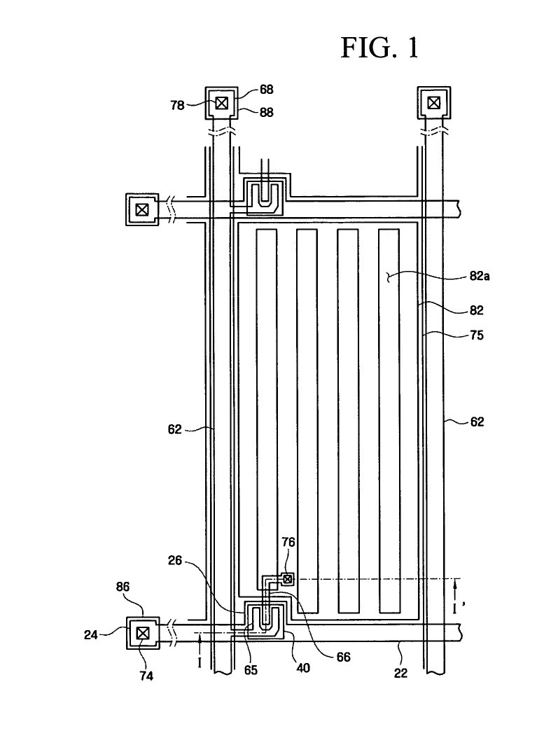

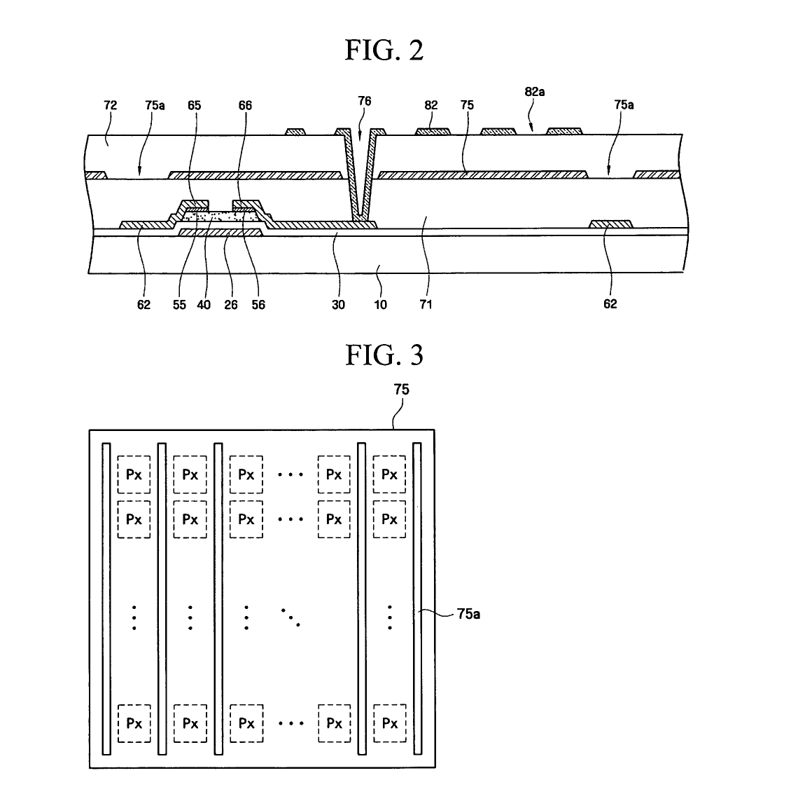

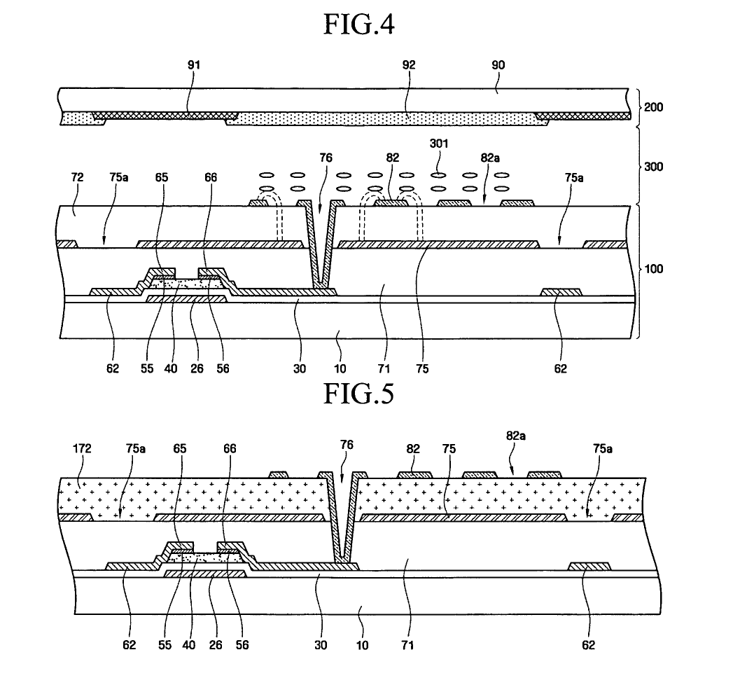

The LCD according to an exemplary embodiment will be described with reference to FIGS. 1 through 4. FIG. 1 is a plan view of a TFT substrate 100 included in an LCD according to an exemplary embodiment. FIG. 2 is a cross-sectional view taken along the line I-I′ of FIG. 1. FIG. 3 is a schematic plan view of a common electrode 75 included in the LCD according to the exemplary embodiment of FIG. 1. FIG. 4 is a schematic cross-sectional view of the LCD according to the exemplary embodiment of FIG. 1.

Referring to FIGS. 1 and 2, the TFT substrate 100 of the LCD according to the exemplary embodiment may include a thin-film transistor (TFT), a first passivation layer 71, a common electrode 75, a second passivation layer 72, and a pixel electrode 82. The TFT may include a gate line 22, a data line 62, a gate electrode 26, a gate insulating film 30, a semiconductor layer 40, and source and drain electrodes 65 and 66 formed on a first substrate 10.

The first substrate 10 may be made of an insulating material such as transparent glass, quartz, ceramic, silicon, or transparent plastic. An appropriate material may be selected for the first substrate 10 according to the needs of those of ordinary skill in the art.

A plurality of gate lines 22 transmitting gate signals may be formed on the first substrate 10 and may extend in a first direction, e.g., a horizontal direction. Typically, one gate line 22 may be allocated to each pixel. A gate pad 24 may receive a signal from an external source and transmit the received signal to the gate line 22. The gate pad 24 may be formed at an end of the gate line 22. The gate pad 24 may be wider, e.g., a little wider, than the gate line 22 in order to, e.g., increase its contact area with an external circuit line.

The gate electrode 26 may branch from the gate line 22 at a location at which the gate line 22 intersects the data line 62 and may be shaped like a protrusion.

The gate line 22, the gate pad 24, and the gate electrode 26 may be referred to as gate wirings. The gate wirings (22, 24 and 26) may be made of aluminum (Al)-based metal such as aluminum or an aluminum alloy, silver (Ag)-based metal such as silver or a silver alloy, copper (Cu)-based metal such as copper or a copper alloy, molybdenum (Mo)-based metal such as molybdenum or a molybdenum alloy, chrome (Cr), titanium (Ti) or tantalum (Ta).

The gate wirings (22, 24 and 26) may have a multi-film structure composed of two conductive films (not shown) with different physical characteristics. One of the two conductive films may be made of metal with low resistivity, such as aluminum-based metal, silver-based metal or copper-based metal, in order to, e.g., reduce a signal delay or a voltage drop of the gate wirings (22, 24 and 26). The other one of the conductive films may be made of a different material, in particular, a material having superior contact characteristics with indium tin oxide (ITO) and indium zinc oxide (IZO), such as molybdenum-based metal, chrome, titanium, or tantalum. Examples of multi-film structures include a chrome lower film and an aluminum upper film and an aluminum lower film and a molybdenum upper film. However, embodiments are not limited thereto, e.g., the gate wirings (22, 24 and 26) may be made of various metals and conductors.

The gate insulating film 30 may be formed on the gate wirings (22, 24 and 26). The gate insulating film 30 may be made of silicon nitride (SiNx) or silicon oxide (SiO₂). The gate insulating film 30 may insulate the gate wirings (22, 24 and 26) from conductive thin films such as the data line 62 disposed on the gate wirings (22, 24 and 26).

The semiconductor layer 40 may be formed on the gate insulating film 30 and may be made of hydrogenated amorphous silicon or polycrystalline silicon. At least a portion of the semiconductor layer 40 may overlap the gate electrode 26. The semiconductor layer 40 may have various shapes. For example, the semiconductor layer 40 may be an island-shaped or may be formed linearly. In FIG. 2, the semiconductor layer 40 is island-shaped. However, embodiments are not limited thereto. The semiconductor layer 40 may form a TFT, together with the gate electrode 26 and the source and drain electrodes 65 and 66, which will be described later. In addition, the semiconductor layer 40 may form a channel.

Ohmic contact layers 55 and 56 formed of, e.g., n+ hydrogenated amorphous silicon heavily doped with n-type impurities, may be disposed on the semiconductor layer 40. The ohmic contact layers 55 and 56 may be arranged between the semiconductor layer 40 thereunder and the source and drain electrodes 65 and 66 thereon to, e.g., reduce contact resistance. The ohmic contact layers 55 and 56 may have various shapes. For example, the ohmic contact layers 55 and 56 may be island-shaped or may be formed linearly. In FIG. 2, the ohmic contact layers 55 and 56 are island-shaped. However, embodiments are not limited thereto. The ohmic contact layers 55 and 56 may expose a predetermined region of the semiconductor layer 40 and may be separated from each other with respect to the semiconductor layer 40.

The source and drain electrodes 65 and 66 may be formed on the gate insulating film 30 and the ohmic contact layers 55 and 56. The source electrode 65 may branch from the data line 62 and may extend over the semiconductor layer 40. The drain electrode 66 may be separated from the source electrode 65 with respect to the gate electrode 26, e.g., the drain electrode 66 may be spaced apart from the source electrode 65 in an area overlapping the gate electrode 26. The drain electrode 66 may extend from over the semiconductor layer 40 onto the gate insulating film 30. The drain electrode 66 may be electrically connected to the pixel electrode 82 and may apply a data voltage to the pixel electrode 82.

The data line 62 may be formed on the gate insulating film 30. The data line 62 may extend in a second direction, e.g., a vertical direction and may transmit a data signal. One data line 62 may be allocated to each pixel. The data line 62 may intersect the gate line 22, and a region formed by the intersection of the data line 62 and the gate line 22 is defined as a pixel region.

A data pad 68 may receive a signal from an external source and transmit the received signal to the data line 62. The data pad 68 may be formed at an end of the data line 62. Like the gate pad 24, the data pad 68 may be wider, e.g., a little wider, than the data line 62 in order to, e.g., increase its contact area with an external circuit line.

The data line 62, the data pad 68, and the source and drain electrodes 65 and 66 are referred to as data wirings (62, 68, 65 and 66). Similarly to the gate wirings (22, 24 and 26), the data wirings (62, 68, 65 and 66) may be made of aluminum, copper, silver, molybdenum, chrome, tantalum, titanium, or an alloy of these materials. In addition, the data wirings (62, 68, 65 and 66) may have a multi-film structure composed of a lower film, which is made of, e.g., refractory metal, and an upper film, which is made of, e.g., a material with low resistivity and is disposed on the lower film. However, embodiments are not limited thereto.

The first passivation layer 71 may be formed on the data wirings (62, 68, 65 and 66) and the exposed region of the semiconductor layer 40. The first passivation layer 71 may be made of an inorganic material such as silicon nitride or silicon oxide, an organic material having photosensitivity and superior planarization characteristics, and/or a low-k insulating material formed by plasma enhanced chemical vapor deposition (PECVD), such as a—Si:C:O or a—Si:O:F. The first passivation layer 71 may be composed of a lower inorganic layer and an upper organic layer in order to, e.g., protect the exposed region of the semiconductor layer 40 while taking advantage of the superior characteristics of an organic layer. A contact hole 76 exposing a predetermined region of the drain electrode 66 may be formed in the first passivation layer 71.

The common electrode 75 may be formed on the first passivation layer 71 and may receive a common voltage to form an electric field together with the pixel electrode 82. According to an exemplary embodiment, since the common electrode 75 may be formed on the first passivation layer 71, it is situated on a higher layer than the data line 62. However, the common electrode 75 is not situated over the data line 62. That is, the common electrode 75 is not formed, e.g., excluded, in a region of the higher layer which overlaps the data line 62. Therefore, the common electrode 75 and the data line 62 do not longitudinally, e.g., along a horizontal direction, overlap each other.

The common electrode 75 according to the exemplary embodiment will now be described in greater detail with reference to FIG. 3. FIG. 3 schematically illustrates the common electrode 75 formed on the first passivation layer 71 of the LCD according to the exemplary embodiment.

Referring to FIGS. 2 and 3, the common electrode 75 may be a substantially rectangular surface electrode and is not divided into a plurality of sections which are arranged in a matrix pattern corresponding to a plurality of pixels, respectively. Therefore, a plurality of pixels, e.g., all pixels, may share one common electrode 75. The common electrode 75 may include gaps 75a in regions thereof, each longitudinally overlapping the data line 62 allocated to each pixel PX. The gaps 75a may be a plurality of openings formed in the common electrode 75. That is, although the common electrode 75 may be formed on a higher layer than the data line 62, it does not overlap the data line 62 since each of the gaps 75a is formed over the data line 62, in each region of the common electrode 75 which overlaps the data line 62. Here, the gaps 75a may extend in a direction in which the data line 62 extends. Each of the gaps 75a may be a hollow region having the same shape as the data line 62. The common electrode 75 may shield both sides, e.g., lateral sides, of the data line 62, thereby reducing and/or preventing the leakage of light.

As described above, the common electrode 75 of the LCD according to an exemplary embodiment may be formed on a higher layer than the data line 62 and shields both sides of the data line 62, thereby reducing and/or preventing the leakage of light due to a fringe field. Here, the common electrode 75 may not be formed over the data line 62, that is, the common electrode 75 may be excluded in a region overlapping the data line 62. Accordingly, this reduces and/or prevents the load of the data line 62 from being increased by the coupling capacitance of the data line 62 and the common electrode 75.

The second passivation layer 72 may be formed on the common electrode 75 and the first passivation layer 71. Like the first passivation layer 71, the second passivation layer 72 may be made of an inorganic material such as silicon nitride or silicon oxide, an organic material having photosensitivity and superior planarization characteristics, and/or a low-k insulating material formed by PECVD, such as a—Si:C:O or a—Si:O:F. The second passivation layer 72 may be composed of a lower inorganic layer and an upper organic layer. The contact hole 76 in the second passivation layer 72 may expose the predetermined region of the drain electrode 66.

The pixel electrode 82 may be formed on the second passivation layer 72. The pixel electrode 82 may receive a data voltage from the drain electrode 66 and may generate an electric field together with the common electrode 75 thereunder, thereby rotating liquid crystal molecules. The pixel electrode 82 may be made of, but is not limited to, a conductive material such as ITO or IZO.

The pixel electrode 82 may include a plurality of hollow slit patterns 82a of various shapes. For example, the slit patterns 82a may have a square, closed curve, or fishbone shape. Due to the slit patterns 82a, an electric field may also be generated in the liquid crystal layer. In FIG. 1, the slit patterns 82a are stripe patterns. However, embodiments are not limited thereto, e.g., the shape of the slit patterns 82a may vary according to the needs of those of ordinary skill in the art. When a data voltage is applied to the pixel electrode 82, an electric field may be generated in a direction from the pixel electrode 82 toward the common electrode 75 disposed under the pixel electrode 82.

The pixel electrode 82 may be connected to the drain electrode 66 through the contact hole 76. The contact hole 76 may be formed in the first passivation layer 71 and the second passivation layer 72. The contact hole 76 may expose the predetermined region of the drain electrode 65. The pixel electrode 82 may be formed along the shape of the contact hole 76 to contact the exposed region of the drain electrode 66. The common electrode 75 may be separated from the contact hole 76 by a predetermined distance and thus does not contact the contact hole 76. Accordingly, the common electrode 75 is not electrically connected to the pixel electrode 82.

An auxiliary gate pad 86 and an auxiliary data pad 88 may be formed on the second passivation layer 72. The auxiliary gate pad 86 may be connected to the gate pad 24 by a contact hole 74, and the auxiliary data pad 88 may be connected to the data pad 68 by a contact hole 78. The auxiliary gate pad 86 and the auxiliary data pad 88 may supplement the adhesion to an external device and protect the gate pad 24 and the data pad 68, respectively. The auxiliary gate pad 86 and the auxiliary data pad 88 may be made of a conductive material. For processing convenience, the auxiliary gate pad 86 and the auxiliary data pad 88 may be made of the same material as the pixel electrode 82.

A first alignment film (not shown) that is capable of aligning the liquid crystal layer may be formed on the pixel electrode 82 and the second passivation layer 72. The first alignment film may be made of, e.g., polyimide.

Referring to FIG. 4, an opposite substrate 200 of the LCD may include a black matrix 91 and color filters 92 formed on a second substrate 90. The liquid crystal layer may include liquid crystal molecules 301 having positive dielectric anisotropy or negative dielectric anisotropy. The liquid crystal layer may be formed between the TFT substrate 100 and the opposite substrate 200.

The second substrate 90 may be made of a transparent insulating material such as glass or transparent plastic.

The black matrix 91 may be formed on the second substrate 90. The black matrix 91 may reduce and/or prevent the leakage of light in certain regions. The black matrix 91, in which the liquid crystal molecules 301 do not operate, may be formed mostly in a TFT region and a non-pixel region, e.g., a region between pixels and a gate line region and a data line region. The black matrix 91 may be made of metal (metal oxide), such as chrome or chrome oxide, and/or organic black resist.

The color filters 92 may be formed between pixel regions of the black matrix 91. The color filters 92 may consist of red (R), green (G) and blue (B) color filters and produce actual colors. Each of the R, G and B color filters 92 may be formed in one pixel to form an R, G, or B pixel. A color produced by the R, G or B pixel may form a dot that constitutes an image to be displayed. An overcoat layer (not shown) may be formed on the color filters 92 to reduce and/or planarize the step difference between the color filters 92.

Specific examples of exemplary first passivation layers and exemplary second passivation layers of the LCD according to exemplary embodiments will now be described with reference to FIG. 5. FIG. 5 is a cross-sectional view of an LCD according to a modified exemplary embodiment.

Referring to FIG. 5, the LCD according to the modified embodiment includes a first passivation layer 71 made of an inorganic material and a second passivation layer 172 made of an organic material.

Specifically, the first passivation layer 71 may be an inorganic layer made of silicon nitride or silicon oxide, and the second passivation layer 72 may be an organic layer made of an organic material which has superior planarization characteristics and facilitates the formation of a thick layer. If the first passivation layer 71 is formed as an organic layer while the second passivation layer 172 is formed as an inorganic layer, there is a risk of damaging the organic layer in the process of forming the second passivation layer 172 on the organic layer. To reduce and/or prevent the damage to the organic layer, the second passivation layer 172 may be formed using a low-temperature process such as a low-temperature CVD process. However, the low-temperature CVD process may deteriorate film characteristics compared to other deposition processes, thereby degrading the performance of the display. However, if the first passivation layer 71 is formed as an inorganic layer as described above, there is no need to form the second passivation layer 172 at a low temperature. Accordingly, there is no risk of deteriorating characteristics of the second passivation layer 172 and thus degrading the performance of the display.

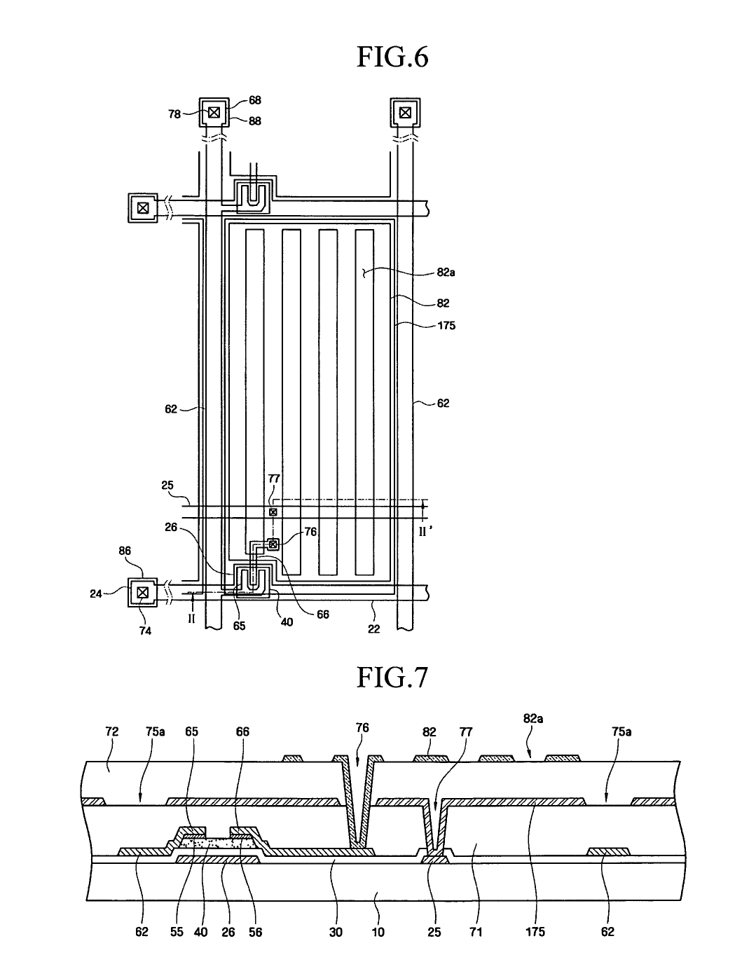

An exemplary LCD according to another embodiment will be described with reference to FIGS. 6 and 7. FIG. 6 is a plan view of a TFT substrate included in an LCD according to another exemplary embodiment. FIG. 7 is a cross-sectional view taken along the II-II′ of FIG. 6.

Referring to FIGS. 6 and 7, the TFT substrate of the LCD according to an exemplary embodiment may include a TFT, a first passivation layer 71, a common electrode 175, a second passivation layer 72, and a pixel electrode 82. The TFT may include a gate line 22, a data line 62, a common electrode line 25, a gate electrode 26, a gate insulating film 30, a semiconductor layer 40, and source and drain electrodes 65 and 66 formed on a first substrate 10. The LCD according to the exemplary embodiment has substantially the same configuration as the LCD of FIG. 1, except for the common electrode 175 and the common electrode line 25. Therefore, the following description will focus on the common electrode 175 and the common electrode line 25, and elements substantially identical to those of the previous embodiment are indicated by like reference numerals and thus a detailed description thereof will be omitted.

The common electrode line 25 may be formed adjacent to the gate line 22 and may extend in a direction in which the gate line 22 extends. The common electrode line 25 may apply a common voltage to the common electrode 175.

The common electrode line 25 may be formed on the same layer as the gate line 22 and the gate electrode 26 on the first substrate 10, and the gate insulating film 30 and the first passivation layer 71 may be formed on the common electrode line 25. A contact hole 77 exposing a predetermined region of the common electrode line 25 may be formed in the gate insulating film 30 and the first passivation layer 71. The common electrode 175 and the common electrode line 25 may be electrically connected through the contact hole 77.

Similarly to the gate line 22, the common electrode line 25 may be made of aluminum, copper, silver, molybdenum, chrome, titanium, tantalum, or an alloy of these materials. For processing convenience, the common electrode line 25 may be formed of the same material as the gate line 22 by the same process.

The common electrode 175 may be formed on the first passivation layer 71 and may be electrically connected to the common electrode line 25 to receive the common voltage. The common electrode 175 may be formed in each pixel region defined by the gate line 22 and the data line 62. In the LCD according to the exemplary embodiment, all pixels may not share one common electrode. Instead, a plurality of common electrodes 175, which are rectangular surface electrodes, may be arranged in a matrix pattern in a plurality of pixel regions, respectively. Therefore, the common electrodes 175 may occupy most of the pixel regions.

The common electrode 175 may not be formed, e.g., may be excluded, in a region over the data line 62. The common electrode 175 may be formed in each pixel region and may be separated from a neighboring common electrode by the interval of a width of the data line 62 centering the data line 62. Therefore, the common electrode 175 may not longitudinally, e.g., in a horizontal direction, overlap the data line 62. According to an exemplary embodiment, since the common electrode 175 does not overlap the data line 62, capacitance generated when the data line 62 and the common electrode 175 overlap each other with an insulating film interposed therebetween is not generated. Accordingly, the load on the data line 62 does not increase.

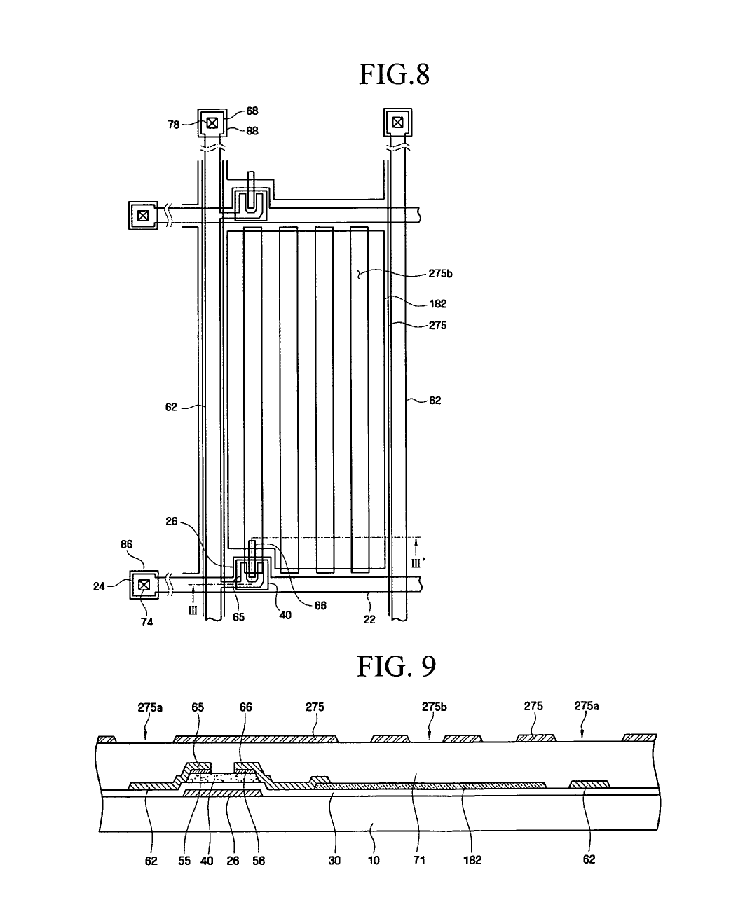

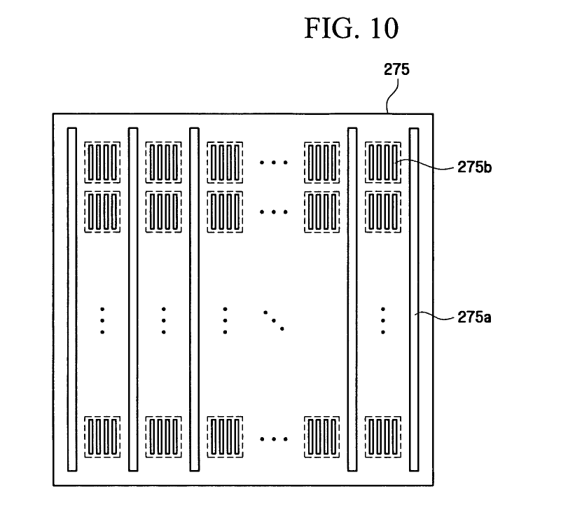

Hereinafter, an LCD according to another exemplary embodiment will be described with reference to FIGS. 8 through 10. FIG. 8 is a plan view of a TFT substrate included in an LCD according to another exemplary embodiment. FIG. 9 is a cross-sectional view taken along the line III-III′ of FIG. 8. FIG. 10 is a schematic plan view of a common electrode 275 formed on a first passivation layer 71 of the LCD according to the exemplary embodiment of FIG. 8.

Referring to FIGS. 8 and 9, the TFT substrate of the LCD according to an exemplary embodiment may include a TFT, the first passivation layer 71, the common electrode 275, and a pixel electrode 182. The TFT may include a gate line 22, a data line 62, a gate electrode 26, a gate insulating film 30, a semiconductor layer 40, and source and drain electrodes 65 and 66 formed on the first substrate 10. The LCD according to the exemplary embodiment may have substantially the same configuration as the LCD of FIG. 1, except for the common electrode 275 and the pixel electrode 182. Therefore, the following description will focus on the common electrode 275 and the pixel electrode 182, and elements substantially identical to those of the previous embodiments are indicated by like reference numerals and thus a detailed description thereof will be omitted.

The pixel electrode 182 may be formed on the gate insulating film 30 and may be connected to the drain electrode 66 to receive a data voltage from the drain electrode 66.

The drain electrode 66 may be separated from the source electrode 65 and may extend from over the semiconductor layer 40 onto the gate insulating film 30. An end of the drain electrode 66 may be in direct contact with the pixel electrode 182 and thus may be electrically connected to the pixel electrode 182.

The data line 62 may be formed on the gate insulating film 30 and may be separated from the pixel electrode 182.

The first passivation layer 71 may be formed on the source and drain electrodes 65 and 66, the pixel electrode 182 and the data line 62, and the common electrode 275 may be formed on the first passivation layer 71. In the LCD according to an exemplary embodiment, since the common electrode 275 is formed on the first passivation layer 71, there is no need to form a second passivation layer. A common voltage may be applied to the common electrode 275. The common electrode 275 may generate an electric field together with the pixel electrode 182, thereby rotating liquid crystal molecules. The common electrode 275 may be formed on a higher layer than the data line 62 and may shield both sides of the data line 62 in order to, e.g., reduce and/or prevent the leakage of light due to a fringe field. While the common electrode 275 may be formed on a higher layer than the data line 62, it is not formed over the data line 62.

The common electrode 275 according to the exemplary embodiment will now be described further detail with reference to FIG. 10. Referring to FIG. 10, the common electrode 275 may be a substantially rectangular surface electrode and may not be divided into a plurality of sections which are arranged in a matrix pattern corresponding a plurality of pixels, respectively. Therefore, a plurality of pixels, e.g., all the pixels, may share one common electrode 275. The common electrode 275 may include a plurality of gaps 275a. The gaps 275a may be a plurality of openings in the common electrode 275. The gaps 275a may extend in a second direction, e.g., in a direction in which the data line 62 extends and may be separated by a predetermined distance to be parallel to each other. Each of the gaps 275a may be a hollow space having the same shape as the data line 62 and formed in a region corresponding to the position of the data line 62 which defines each pixel region together with the gate line 22. Accordingly, the common electrode 275 is not formed over the data line 62, which, in turn, reduces and/or prevents an increase in the load of the data line 62 caused by the overlapping of the data line 62 and the common electrode 275.

The common electrode 275 may include a plurality of slit patterns 275b formed in each pixel. The slit patterns 275b may be formed in addition to the gaps 275a in the common electrode 275. The slit patterns 275b may have various shapes. For example, the slit patterns 275b may have a rectangular, closed curve, or fishbone shape. In FIG. 10, the slit patterns 275b are rectangular stripes. However, embodiments are not limited thereto.

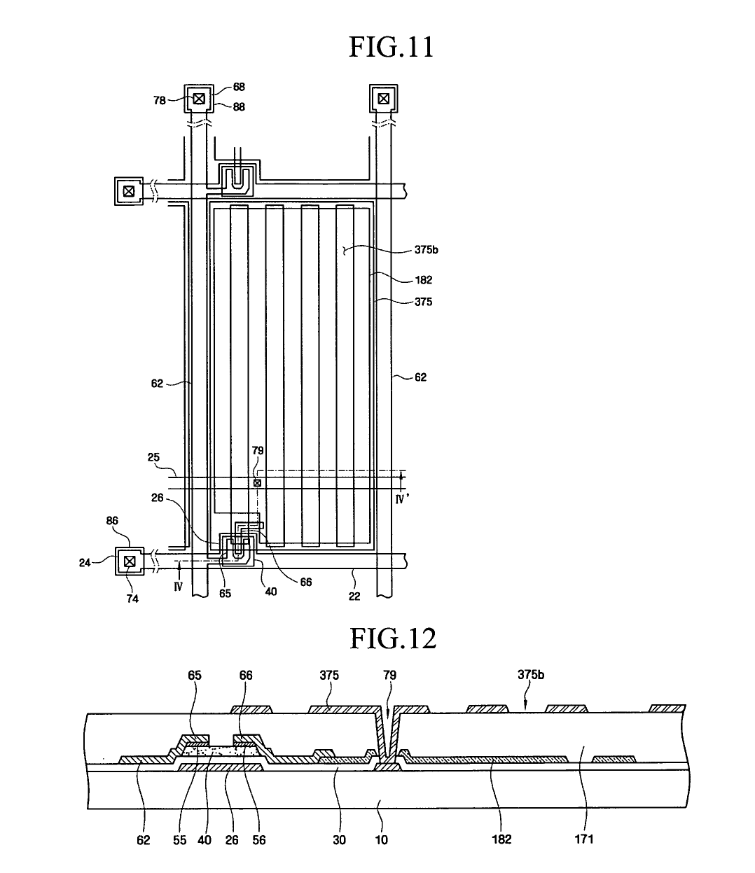

Hereinafter, an LCD according to another exemplary embodiment will be described with reference to FIGS. 11 and 12. FIG. 11 is a plan view of a TFT substrate included in an LCD according to another exemplary embodiment. FIG. 12 is a cross-sectional view taken along the line IV-IV′ of FIG. 11.

Referring to FIGS. 11 and 12, the TFT substrate of the LCD according to the exemplary embodiment may include a TFT, the first passivation layer 71, a common electrode 375, and a pixel electrode 182. The TFT may include a gate line 22, a data line 62, a common electrode line 25, a gate electrode 26, a gate insulating film 30, a semiconductor layer 40, and source and drain electrodes 65 and 66 formed on a first substrate 10. The LCD according to the exemplary embodiment may have substantially the same configuration as the LCD of FIG. 8, except for the common electrode 375 and the common electrode line 25. Therefore, the following description will focus on the common electrode line 25 and the common electrode 375, and elements substantially identical to those of the previous embodiments are indicated by like reference numerals and thus a detailed description thereof will be omitted.

The common electrode line 25 may be formed on the same layer as the gate electrode 26 and the gate line 22 on the first substrate 10 and may be substantially parallel to the gate line 22. The common electrode line 25 may be electrically connected to the common electrode 375 and may apply a common voltage to the common electrode 375. The common electrode line 25 may be made of a conductive material. For processing convenience, the common electrode 25 may be made of the same material as the gate line 22 and the gate electrode 26.

The gate insulating film 30 may be formed on the common electrode line 25. The first passivation layer 71 may be formed on the source and drain electrodes 65 and 66, the pixel electrode 182, and the data line 62. A contact hole 79 may electrically connect the common electrode line 25 and the common electrode 375. The contact hole 79 may be formed in the first passivation layer 71.

The common electrode 375 may be formed on the first passivation layer 71. The common electrode 375 may be connected to the common electrode line 25 through the contact hole 79 and may receive the common voltage from the common electrode line 25. The common electrode 375 may form an electric field together with the pixel electrode 182 disposed thereunder.

The common electrode 375 may be a substantially rectangular surface electrode and may be formed in each pixel region. That is, a plurality of common electrodes 375 may be arranged in a matrix pattern in a plurality of pixel regions, respectively, and occupy most of the pixel regions. In a direction along the gate line 22, the common electrode 375 formed in each pixel may be separated from a neighboring common electrode 375 by interval of a width of the data line 62 centering the data line 62. Each common electrode 375 may be arranged such that the data line 62 is centered between neighboring common electrodes 375. In a direction along the data line 62, the common electrode 375 formed in each pixel may be separated from a neighboring common electrode by the gate line 22. Here, the common electrode 375 may overlap a predetermined region of the gate line 22 but may not overlap the data line 62 since it is formed in each pixel to be separated from a neighboring common electrode 375 by the width of the data line 62. According to an exemplary embodiment, since the common electrode 375 does not overlap the data line 62, capacitance generated when the data line 62 and the common electrode 375 overlap each other with an insulating film interposed therebetween is not generated. Accordingly, the load on the data line 62 does not increase.

The common electrode 375 may include a plurality of slit patterns 375b which are hollow spaces of a rectangular or closed curve shape. The slit patterns 375b may be formed in each pixel region. In FIG. 11, the slit patterns 375b may be stripes. However, embodiments are not limited thereto.

As described above, in an LCD according to an exemplary embodiment, a common electrode is formed in a layer above a data line thereby to reduce and/or prevent the leakage of light due to a fringe field. However, the common electrode is not formed directly above the data line, that is, in a region overlapping the data line. Accordingly, the load on the data line does not increase.

Features of the above embodiments relate to a liquid crystal display (LCD) in which the leakage of light may be reduced and/or prevented, and the load on a data line may be reduced. However, features of the embodiments are not restricted to the one set forth herein. The above and other features will become more apparent to one of ordinary skill in the art to which the present invention pertains by referencing the detailed description given below.

By way of summation and review, LCDs can be made thin, consume relatively low power, and hardly generate electromagnetic waves harmful to the human body. However, since their lateral visibility is poor compared to front visibility, various methods of arranging liquid crystals and various driving methods are being developed to overcome this drawback.

For a wide viewing angle, plane to line switching (PLS) mode LCDs are being suggested. In a PLS mode LCD, a common electrode and a pixel electrode may be placed on one display substrate, and the gap between the common electrode and the pixel electrode may be made to be smaller than that between upper and lower display substrates, thereby generating a fringe field over the common electrode and the pixel electrode. However, the fringe field may cause the leakage of light in the vicinity of a data line. If the width of a black matrix is increased to reduce the leakage of light, an aperture ratio is reduced, which, in turn, reduces luminance.

In order to reduce and/or prevent the leakage of light in the vicinity of a data line in a PLS mode LCD, the data line may be shielded using another electrode. In this structure, however, the coupling capacitance of the data line and the electrode may increase the load on the data line and increase power consumption.

Exemplary embodiments, as discussed above, relate to a liquid crystal display (LCD), and more particularly, to an LCD in which the leakage of light maybe reduced and/or prevented, and the load on a data line may be reduced and/or not increases.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A liquid crystal display (LCD), comprising:
a gate line and a data line on a substrate and intersecting each other;
a pixel region defined by the gate line and the data line;
a pixel electrode in the pixel region;
a thin-film transistor (TFT) in the pixel region, the TFT being configured to apply a voltage to the pixel electrode; and
a common electrode over or under the pixel electrode, the common electrode being configured to generate an electric field with the pixel electrode and being on a higher layer than the data line, and the common electrode being excluded in a region of the higher layer that overlaps the data line.

2. The LCD of claim 1, further comprising a common electrode line on the substrate, the common electrode line being parallel to the gate line and being configured to apply a common voltage to the common electrode.

3. The LCD of claim 2, wherein the common electrode line is on a same layer as the gate line.

4. The LCD of claim 1, further comprising:
a first passivation layer on the TFT and the data line, the common electrode being on the first passivation layer, and
a second passivation layer on the common electrode, and the pixel electrode being on the second passivation layer.

5. The LCD of claim 4, wherein the first passivation layer is made of an inorganic material, and the second passivation layer is made of an organic material.

6. The LCD of claim 4, wherein the pixel electrode includes a plurality of slit patterns.

7. The LCD of claim 1, further comprising a passivation layer, the pixel electrode being connected to the TFT, the passivation layer being on the TFT and the pixel electrode, and the common electrode being on the passivation layer.

8. The LCD of claim 7, wherein the common electrode includes a plurality of slit patterns.

9. A liquid crystal display (LCD), comprising:
a gate electrode on a substrate;
a gate insulating film on the gate electrode;
a semiconductor layer on the gate insulating film and overlapping the gate electrode;
a data line on the gate insulating film;
source and drain electrodes on the semiconductor layer and the gate insulating film, the source and drain electrodes being separated from each other by a predetermined gap;
a first passivation layer on a surface of the substrate having the source and drain electrodes and the data line;
a common electrode on the first passivation layer, the common electrode being excluded in a region of the first passivation layer that overlaps the data line;
a second passivation layer on the common electrode; and
a pixel electrode on the second passivation layer.

10. The LCD of claim 9, wherein the first passivation layer is made of an inorganic material, and the second passivation layer is made of an organic material.

11. The LCD of claim 10, wherein the first passivation layer is made of SiNx or SiO₂.

12. The LCD of claim 9, wherein the first passivation layer and the second passivation layer are made of SiNx or SiO₂.

13. The LCD of claim 9, wherein the pixel electrode is connected to the drain electrode.

14. The LCD of claim 9, wherein the pixel electrode includes a plurality of slit patterns.

15. The LCD of claim 9, further comprising a common electrode line on a same layer as the gate electrode.

16. The LCD of claim 15, wherein the common electrode line is connected to the common electrode through a contact hole formed in the first passivation layer and is configured to apply a common voltage to the common electrode.

17. The LCD of claim 16, wherein the common electrode is separated from the contact hole by a predetermined gap and is not in contact with the contact hole.

18. A liquid crystal display (LCD), comprising:
a gate electrode on a substrate;
a gate insulating film on the gate electrode;
a semiconductor layer on the gate insulating film and overlapping the gate electrode;
a data line on the gate insulating film;
source and drain electrodes on the semiconductor layer and the gate insulating film, the source and drain electrodes being separated from each other with respect to the gate electrode;
a pixel electrode on the gate insulating film and connected to the drain electrode;
a passivation layer on a surface of the substrate having the source and drain electrodes, the pixel electrode, and the data line; and
a common electrode on the passivation layer, the common electrode being excluded in a region of the passivation layer that overlaps the data line.

19. The LCD of claim 18, wherein the common electrode includes a plurality of slit patterns.

20. The LCD of claim 18, further comprising a common electrode line on a same layer as the gate electrode.

21. The LCD of claim 20, wherein the common electrode line is connected to the common electrode through a contact hole in the passivation layer and is configured to apply a common voltage to the common electrode.
